(19) United States
(12) Patent Application Publication
(10) Pub. No.: US 2005/0123830 A1
(43) Pub. Date: Jun. 9, 2005

(54) Parallel rib battery cover

(75) Inventors: James S. Hardigg, Conway, MA (US); Mark C. Gaydos, Greenfield, MA (US)

Correspondence Address: MCCORMICK, PAULDING & HUBER LLP, CITY PLACE II, 185 ASYLUM STREET, HARTFORD, CT, 06103, US

(73) Assignee: HARDIGG INDUSTRIES, INC., South Deerfield, MA (US)

(21) Appl. No.: 10/982,334

(22) Filed: Nov. 5, 2004

Related U.S. Application Data
(60) Provisional application No. 60/527,400, filed on Dec. 5, 2003.

(51) Int. Cl. H01M 2/04; H01M 2/36

(52) U.S. Cl. 429/175; 429/72

(57) ABSTRACT

A battery cover includes a planar section and an aperture formed through the planar section. A rib extends outwardly from the planar section and is substantially tangential to the aperture.

### CROSS REFERENCE TO RELATED APPLICATIONS

This application claims the benefit of U.S. Provisional Patent Application Ser. No. 60/527,400 filed on Dec. 5, 2003, entitled “PARALLEL RIB BATTERY COVER,” herein incorporated by reference in its entirety.

### FIELD OF THE INVENTION

This invention relates in general to a battery cover, and deals more particularly with a battery cover having parallel ribs formed on the underside thereof, thus providing greater structural rigidity and integrity.

### BACKGROUND OF THE INVENTION

Over the past 25 years, containers for lead-acid batteries have come to be made chiefly of polypropylene. As a structural material, polypropylene exhibits the desired chemical resistance and strength over the temperature ranges in which motive-power and automotive batteries normally operate. Moreover, the use of polypropylene material is economically viable in the large-scale production of battery containers.

The covers utilized with polypropylene battery containers are typically attached to the body of the battery jar via hot-plate welding operation or the like. Prior to the use of polypropylene, hard rubber was utilized for lead-acid battery containers, and their covers were attached and sealed with asphalt. Asphalt seals, however, were not as strong or as durable as welded polypropylene seals.

Despite these drawbacks, one benefit of containers and covers made from hard rubber is that they exhibit a higher stiffness modulus than does polypropylene. Covers are preferably stiff in the area surrounding the filling hole, as it is undesirable for this area to become depressed by forces exerted during the filling process. Any such depression in this area may promote the collection of acid, water and contaminates which may get inside the battery and thus lead to possible catastrophic failure of the battery as a whole.

It is also desirable that the peripheral area surrounding the filling hole remains substantially flat so that a gasket disposed between the filling hole and a filler cap will seal well.

Given the desire in the art for stiff battery covers, stiffening in the area surrounding the filling hole has been previously addressed by several differing techniques. One technique involves providing a cylindrical skirt 10 that depends from the periphery of the filling hole, together with radially extending gussets 12 between the skirt and the underside of the top of the cover, as shown in FIGS. 1-3. These measures have been adequate for hard-rubber covers, but have been found to be somewhat lacking in stiffness, in certain situations, when utilized with covers made from polypropylene.

Another known technique involves simply making the battery cover thicker. Although marginally effective, such a technique increases material use and hence directly affects cost. Moreover, thicker battery covers would also indirectly affect the cost of each cover as a result of the longer cooling times inherently required during/after the molding process.

With the forgoing problems and concerns in mind, it is the general object of the present invention to provide a battery cover which overcomes the above-described drawbacks while providing greater structural rigidity and integrity.

### SUMMARY OF THE INVENTION

It is an object of the present invention to provide a battery cover.

It is another object of the present invention to provide a battery cover that provides greater structural rigidity and integrity.

It is another object of the present invention to provide a battery cover that provides greater structural rigidity and integrity without substantially increasing molding time and cost.

It is another object of the present invention to provide a battery cover having parallel ribs formed on the underside thereof, thus providing greater structural rigidity and integrity.

According, therefore, to one embodiment of the present invention, a battery cover includes a planar section and an aperture formed through the planar section. A rib extends outwardly from the planar section and is substantially tangential to the aperture.

These and other objectives of the present invention, and their preferred embodiments, shall become clear by consideration of the specification, claims and drawings taken as a whole.

### BRIEF DESCRIPTION OF THE DRAWINGS

FIG. 1 is a top plan view of a known battery cover.

FIG. 2 is a bottom plan view of a known battery cover.

FIG. 3 is a cross-sectional view is of the battery cover shown in FIGS. 1 and 2.

FIG. 4 illustrates a perspective view of a battery cover according to one embodiment of the present invention.

FIG. 5 illustrates a top plan view of the battery cover shown in FIG. 4.

FIG. 6 illustrates a bottom plan view of the battery cover shown in FIG. 4.

FIG. 7 illustrates a perspective view of the bottom of the cover shown in FIG. 4.

FIG. 8 illustrates a cross-section view of the cover shown in FIG. 4.

FIG. 9 illustrates a finite element analysis of the force-deflection relationship of the cover design of the present invention compared with that of a known design.

FIG. 10 illustrates a cover according to another embodiment of the present invention.

FIGS. 11-14 illustrate a cover according to another embodiment of the present invention.

FIGS. 15 and 16 illustrate a top plan view and a bottom plan view, respectively, of a battery cover 20, according to another embodiment of the present invention.

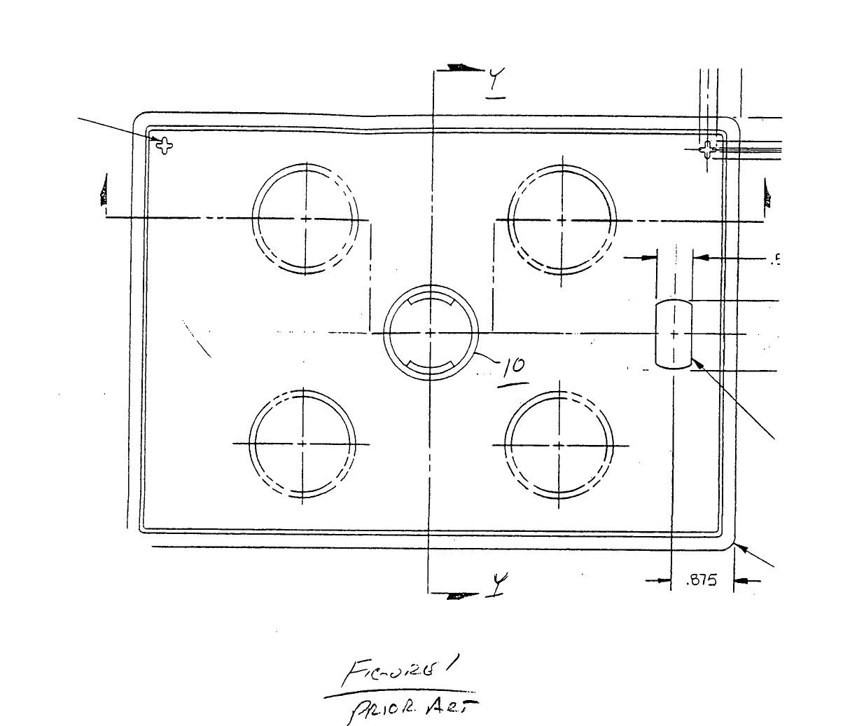

### DETAILED DESCRIPTION OF THE PREFERRED EMBODIMENT

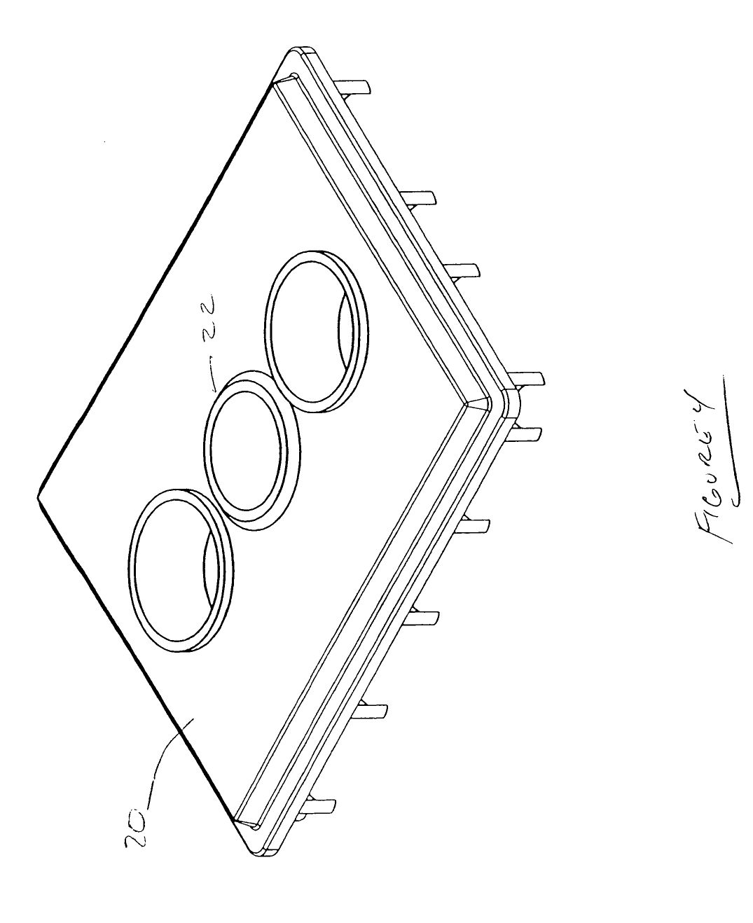

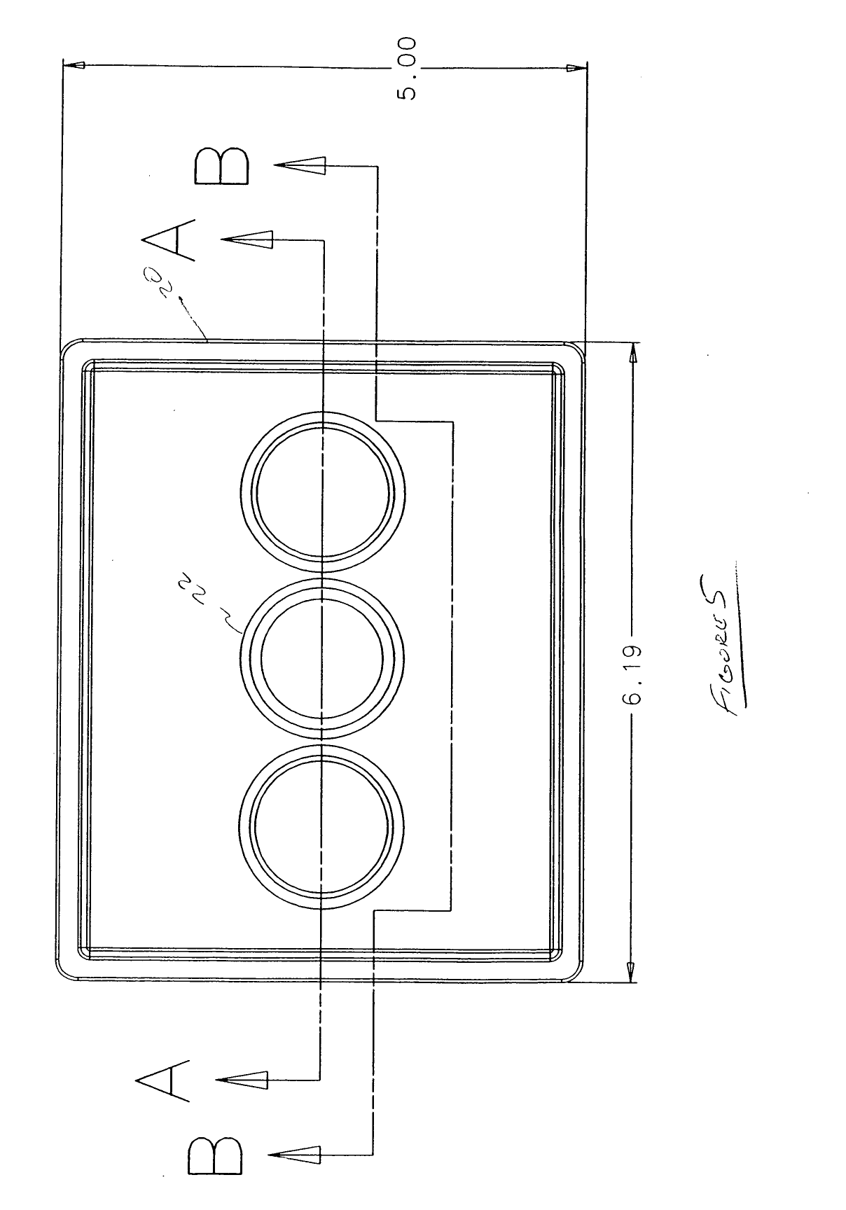

FIGS. 4 and 5 illustrate a perspective and a top plan view, respectively, of a planar battery cover 20, according to one embodiment of the present invention. As shown in FIGS. 4 and 5, a plurality of filling apertures for posts may be formed in the cover 20, with a filling hole 22 typically defined in the middle thereof.

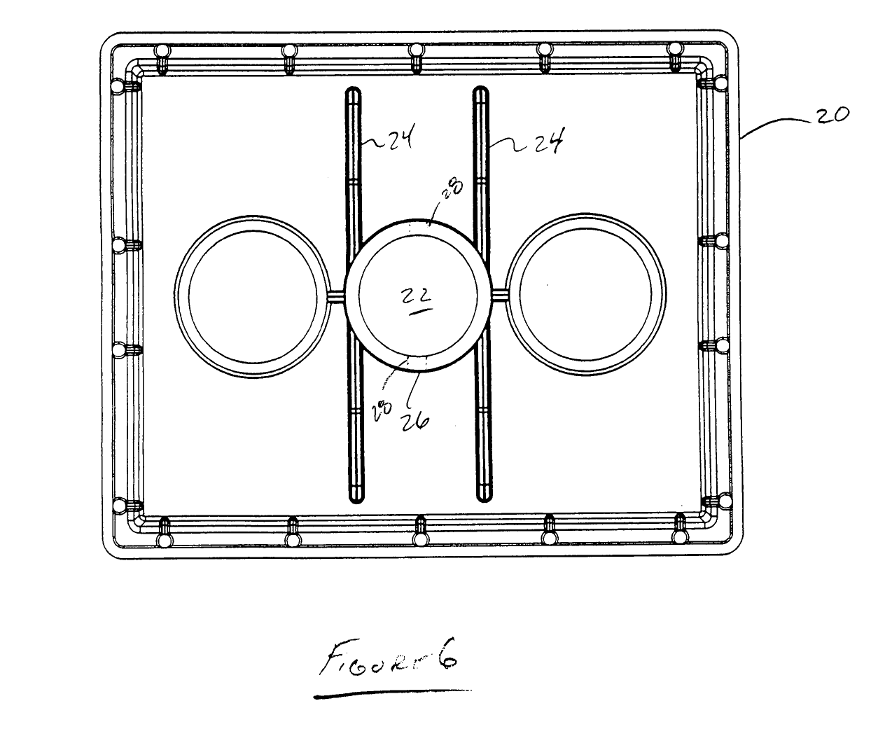

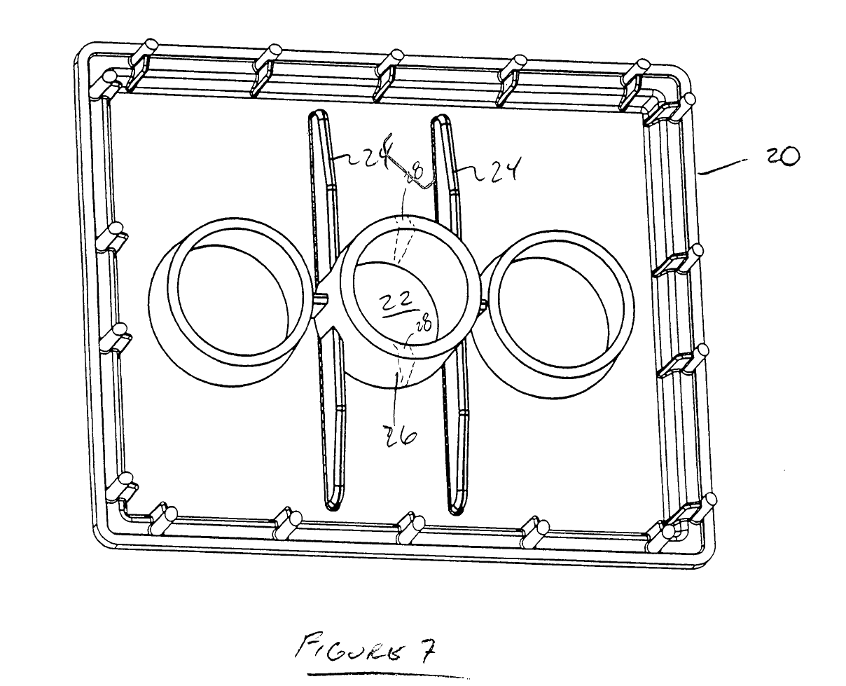

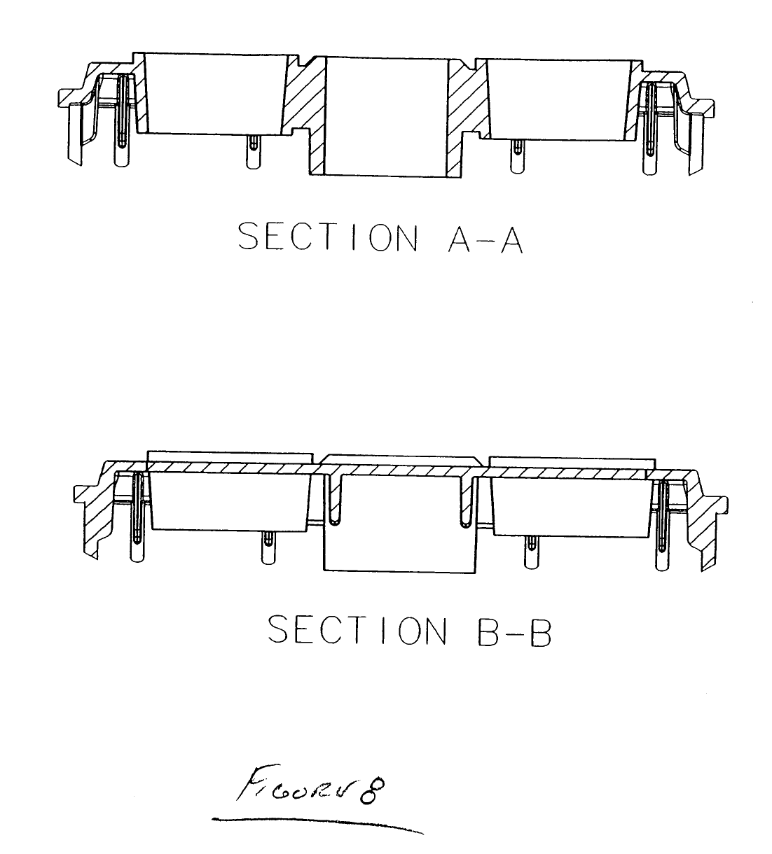

FIG. 6 illustrates a bottom plan view of the battery cover 20. As shown in FIG. 6, the cover 20 includes two, preferably parallel, strengthening and stiffening ribs 24 provided on the underside of the cover 20. The ribs 24 run from adjacent one side of the cover 20 to adjacent the other side of the cover 20. In the preferred embodiment of the present invention, the ribs 24 are tangential to the skirt 26 and blend into the material of the cylindrical skirt 26 which depends downwardly from the cover 20. A pair of venting slots 28 are provided in the cylindrical skirt 26 for gas venting through the cap that covers the filing hole 22. FIG. 7 illustrates a perspective view of the cover 20 and the ribs 24 shown in FIG. 6. FIG. 8 illustrates a cross-section view of the cover 20 and the ribs 24 shown in FIG. 6.

Returning to FIG. 6, the ribs 24 are preferably straight and continuous and run substantially through the center of the cover 20. It is important to note, however, that in the preferred embodiment of the present invention, the ribs 24 do not extend all the way to the edges of the cover 20, thereby allowing a passage for any extraneous gasses to migrate around their ends to the pair of venting slots 28, typically formed in the cylindrical skirt 26, as mentioned previously, and as shown in phantom in FIG. 7.

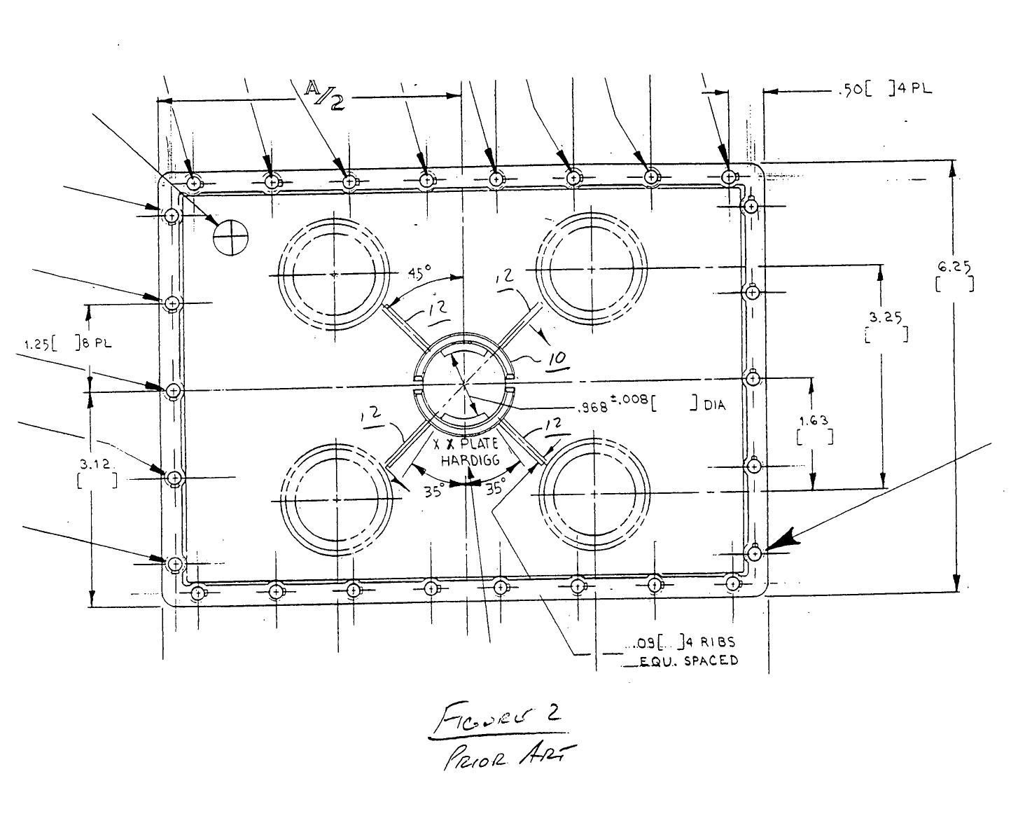

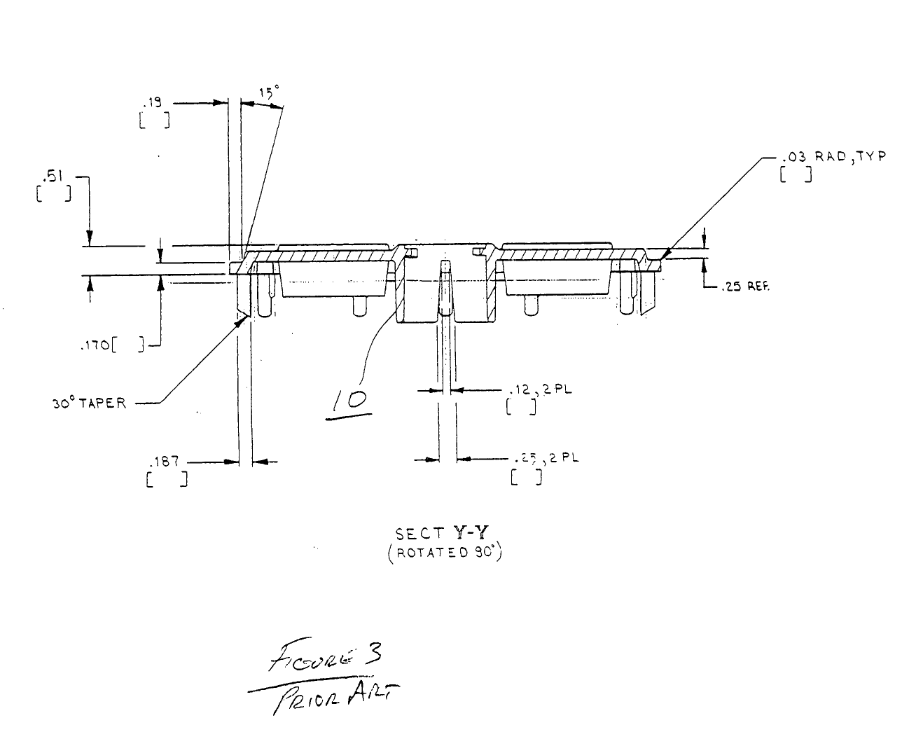

It is therefore an important aspect of the present invention that the ribs 24 in conjunction with the cylindrical skirt 26 provide a cover 20 that is stronger and stiffer than known battery covers which utilize known radially extending gussets (best seen in FIG. 2). These radially extending gussets are not efficient in reducing deflection around the filling hole primarily because the cylindrical skirt to which the radially extending gussets are attached can deflect radially.

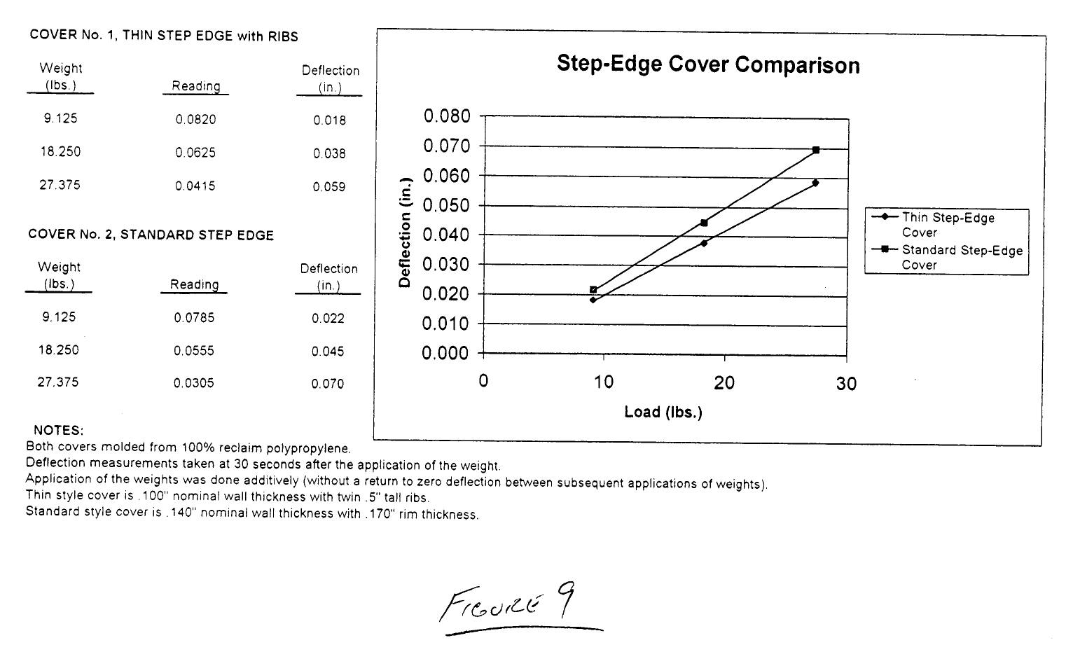

FIG. 9 illustrates a finite element analysis of the force-deflection relationship of the cover design of the present invention compared with that of a known design, illustrating that a cover having the ribs 24 in accordance with the present invention is significantly stronger and stiffer than the known radially extending gusset design.

As shown in FIG. 9, two plate cover designs were examined, both formed from polypropylene. A cover formed with the ribs 24 in accordance with the present invention, termed a ‘thin step edge cover’ in FIG. 9, was formed with a thickness of 0.095 inches, while a cover with the known radially extending gusset design, termed a ‘standard step edge cover’ in FIG. 9, was formed with a thickness of 0.140 inches.

As shown in FIG. 9, the parallel rib design of the present invention deflected 16% less than did the known radially extending gusset cover design, even though the thickness of the parallel rib design was 32% less.

It will be readily appreciated that the present invention therefore increases strength and stiffness while also reducing material cost, and molding and cooling time.

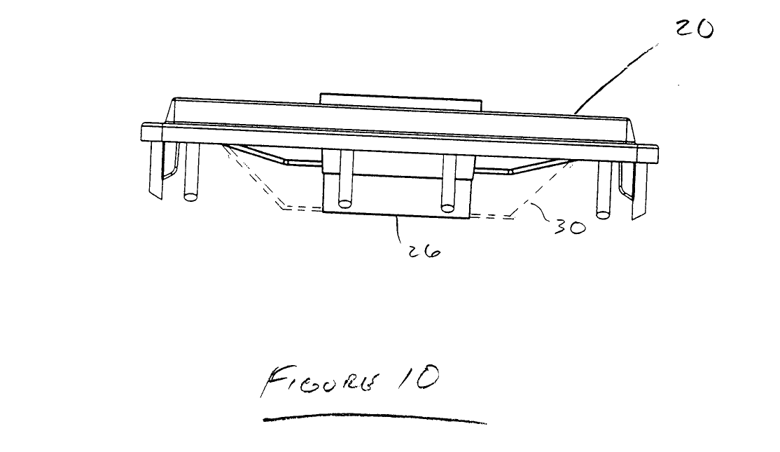

FIG. 10 illustrates another embodiment of the present invention where the parallel ribs 30 may be formed to a height which is substantially equal to the depth of the downwardly extending cylindrical skirt 26. A proportional increase in the strength and stiffness of the embodiment shown in FIG. 10 over that exhibited by the design shown in FIGS. 4-9 will be readily appreciated.

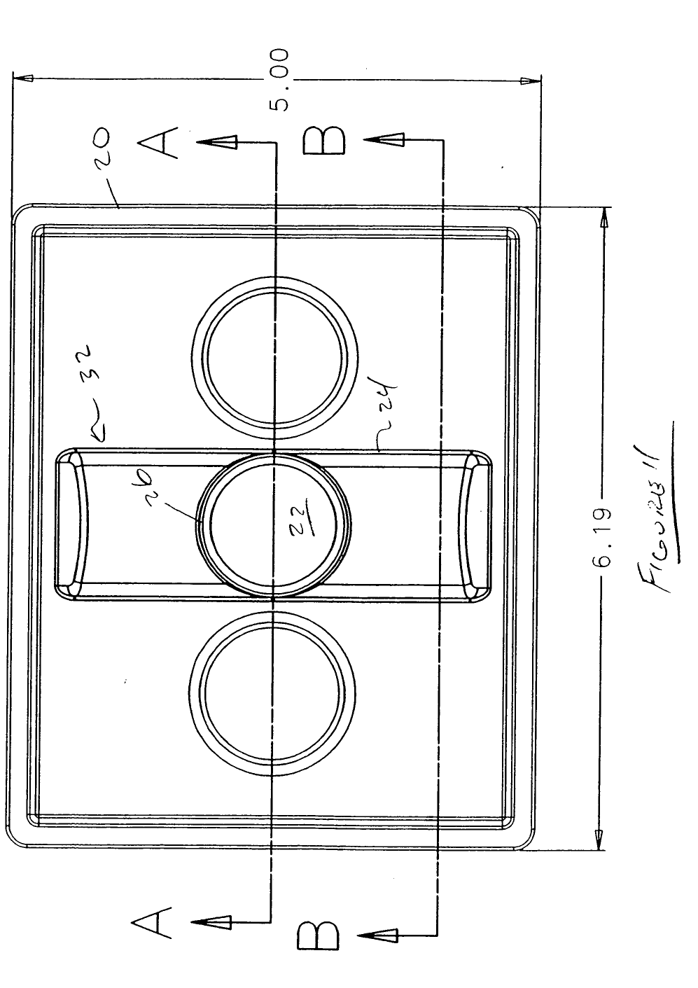

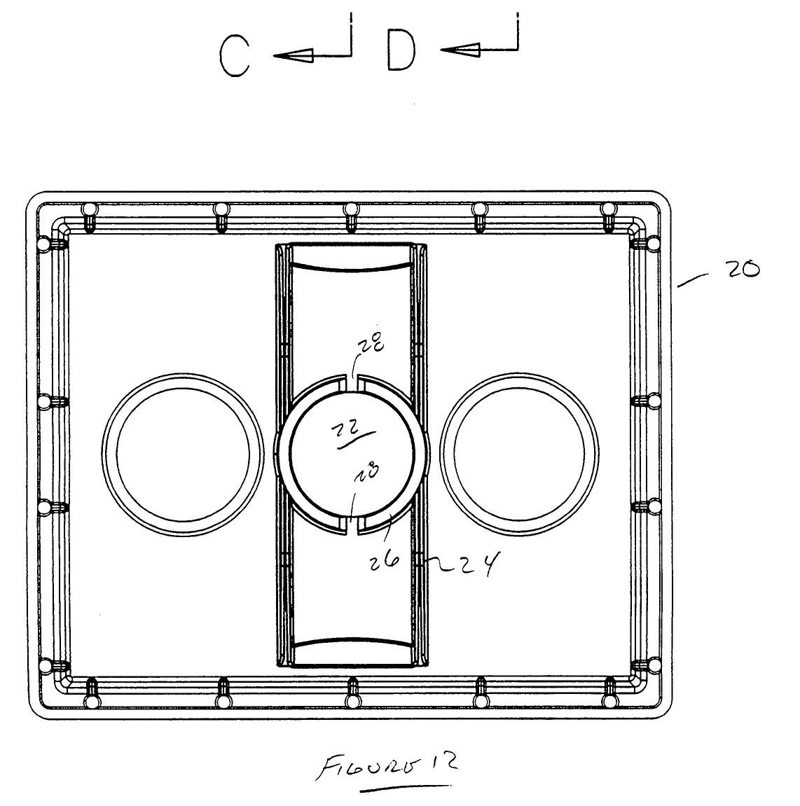

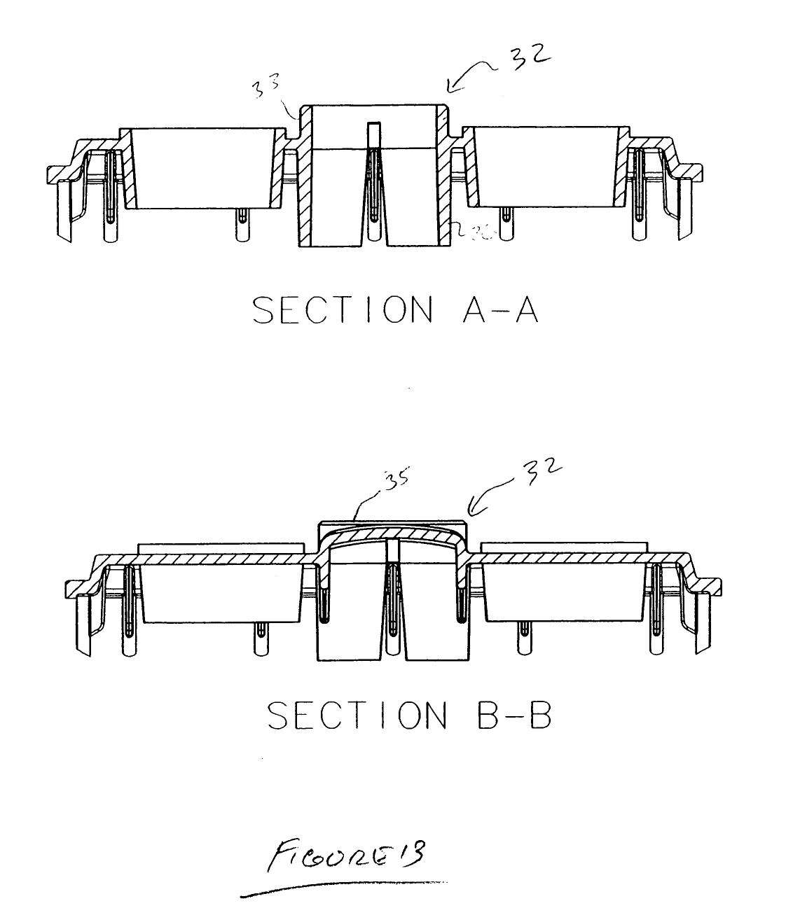

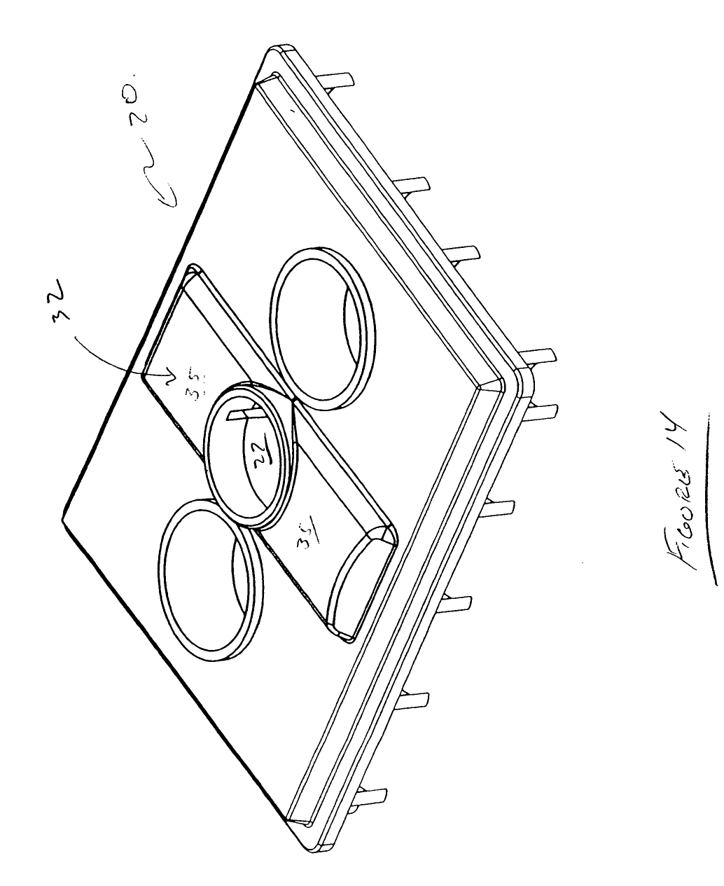

Further increases in both strength and stiffness can also be accommodated without making the ribs 26 extend deeper into the battery cell by alternatively providing a raised area 32 across the area of the filling hole 22, as shown in FIGS. 11-14. As best shown in FIGS. 13 and 14, the raised area 32 is defined by a pair of raised ribs 33 which extend outwardly and upwardly from the planar cover 20. As will be appreciated, these ribs 33 are preferably tangential to the filling hole 22 and substantially define the edges of the raised area 32.

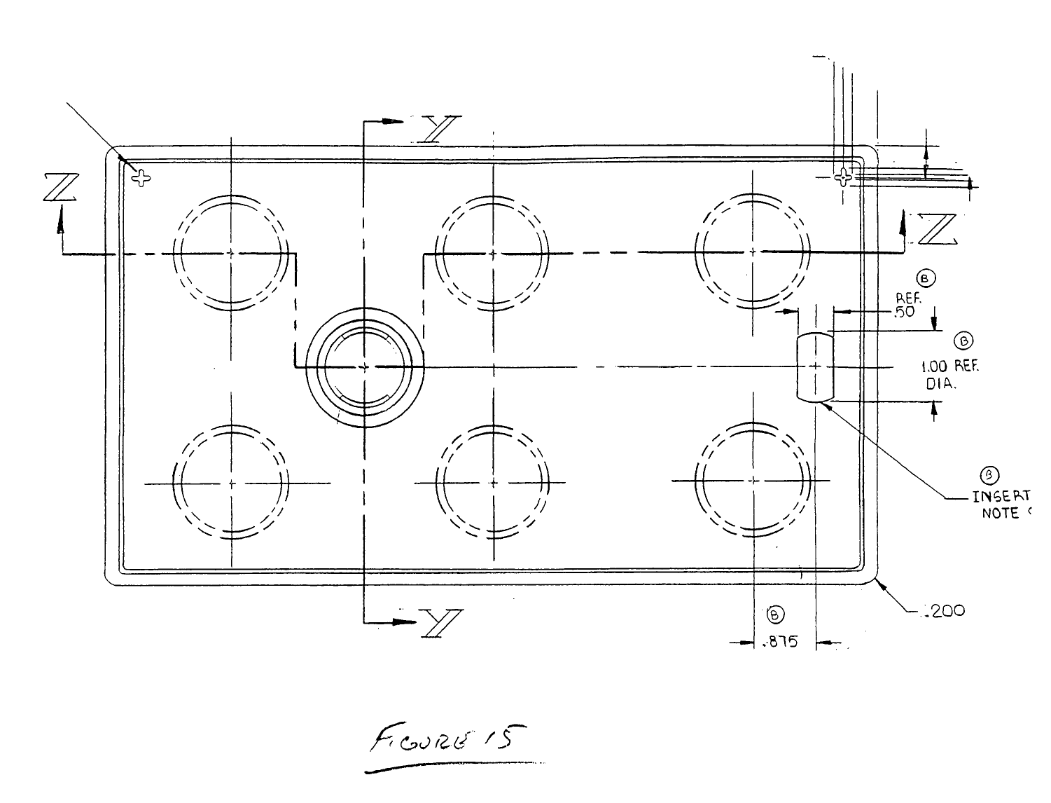

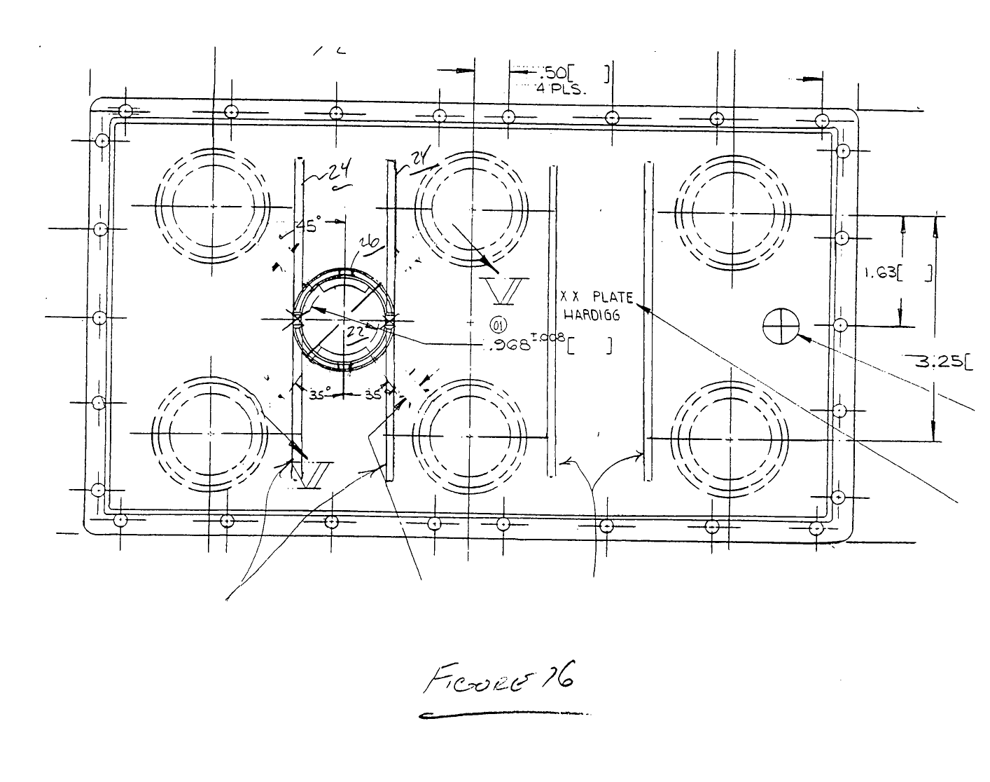

FIGS. 15 and 16 illustrate a top plan view and a bottom plan view, respectively, of a battery cover 20, according to another embodiment of the present invention. As shown in FIGS. 15 and 16, covers for six-post battery cells typically have the filling hole 22 located between the four posts at one end of the cover 20. In this embodiment, the ribs 24 may be provided for the filling hole, while additional ribs may also be provided between the four posts at the other end of the cover as well.

As will be appreciated by a review of the drawing figures, the ribs 24 are preferably aligned so as to be substantially orthogonal to the elongated edges of the cover 20. That is, in the preferred embodiment of the present invention, the ribs 24 are oriented to be substantially orthogonal to the two, longest opposing edges of the cover 20, for maximum effect.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all equivalent embodiments.

1. A battery cover, comprising:
a planar section;
an aperture formed through said planar section;
a rib extending outwardly from said planar section; and
wherein said rib is substantially tangential to said aperture.

2. The battery cover according to claim 1, wherein:
said aperture includes a skirt extending outwardly from said planar section; and
said rib forms a portion of said skirt.

3. The battery cover according to claim 2, wherein:
said aperture is a battery filling hole.

4. The battery cover according to claim 1, wherein:
said rib extends from proximate a first edge of said planar section, to proximate a second edge of said planar section.

5. The battery cover according to claim 4, wherein:
said first edge and said section edge are opposing and substantially parallel edges.

6. The battery cover according to claim 2, wherein:
said rib extends one of above and below said planar section; and
said skirt extends one of above and below said planar section.

7. A battery cover, comprising:
a planar section;
an aperture formed through said planar section;
a first rib extending outwardly from said planar section;
a second rib extending outwardly from said planar section, said first rib and said second rib being substantially parallel to one another; and
wherein said first rib and said second rib are substantially tangential to said aperture.

8. The battery cover according to claim 7, wherein:
said aperture includes a skirt extending outwardly from said planar section; and
said first rib and said second rib form a portion of said skirt.

9. The battery cover according to claim 8, wherein:
said aperture is a battery filling hole.

10. The battery cover according to claim 7, wherein:
said first rib and said second rib extend from proximate a first edge of said planar section, to proximate a second edge of said planar section.

11. The battery cover according to claim 10, wherein:
said first edge and said section edge are opposing and substantially parallel edges.

12. The battery cover according to claim 8, wherein:
said first rib and said second rib extend one of above and below said planar section; and
said skirt extends one of above and below said planar section.

13. A battery cover, comprising:
a planar section having an elongated pair of opposing edges and a shorter pair of opposing edges;
an aperture formed through said planar section;
a first rib extending outwardly from said planar section;
a second rib extending outwardly from said planar section, said first rib and said second rib being substantially parallel to one another; and
wherein said first rib and said second rib are substantially orthogonal to said elongated pair of opposing edges.

14. A method of strengthening a battery cover, said method comprising the steps of:
forming a substantially planar section;
forming an aperture through said planar section;
forming a rib to extend outwardly from said planar section; and
orienting said rib so as to be substantially tangential to said aperture.

15. The method of strengthening a battery cover according to claim 14, said method further comprising the steps of:
forming a skirt about the circumference of said aperture, said skirt extending outwardly from said planar section; and
orienting said rib so as to form a portion of said skirt.

16. The method of strengthening a battery cover according to claim 15, said method further comprising the steps of:
extending said rib from proximate a first edge of said planar section, to proximate a second edge of said planar section.

17. The method of strengthening a battery cover according to claim 15, said method further comprising the steps of:
forming said first edge and said section edge to be opposing and substantially parallel edges.

18. The method of strengthening a battery cover according to claim 1, said method further comprising the steps of:
extending said rib one of above and below said planar section; and
extending said skirt one of above and below said planar section.

19. The method of strengthening a battery cover according to claim 1, said method further comprising the steps of:
forming a venting slot in said skirt.

20. The method of strengthening a battery cover, said method comprising the steps of:
forming a planar section to include an elongated pair of opposing edges and a shorter pair of opposing edges;
forming an aperture through said planar section;
extending a first rib outwardly from said planar section;
extending a second rib outwardly from said planar section, said first rib and said second rib being substantially parallel to one another; and
orienting said first rib and said second rib so as to be substantially orthogonal to said elongated pair of opposing edges.
